(19) United States
(12) Patent Application Publication
(10) Pub. No.: US 2017/0255144 A1
(43) Pub. Date: Sep. 7, 2017

(54) FIXING DEVICE AND IMAGE FORMING APPARATUS

(71) Applicant: FUJI XEROX CO., LTD., Tokyo (JP)

(72) Inventors: Jouta KOBAYASHI, Kanagawa (JP); Yasutaka GOTOH, Kanagawa (JP); Sou MORIZAKI, Kanagawa (JP); Kyogo SOSHI, Kanagawa (JP); Hiroko FURUKATA, Kanagawa (JP)

(73) Assignee: FUJI XEROX CO., LTD., Tokyo (JP)

(21) Appl. No.: 15/220,915

(22) Filed: Jul. 27, 2016

(30) Foreign Application Priority Data
Mar. 3, 2016 (JP) 2016-041044

(51) Int. Cl. G03G 15/20

(52) U.S. Cl. CPC G03G 15/2053

(57) ABSTRACT

A fixing device includes a heating belt that is provided rotatably around an orthogonal direction orthogonal to a transport direction of a recording medium as an axial direction, and is configured to heat a developer on the recording medium; a support member that is provided inside the heating belt and supports the heating belt; and plural pressing rotational bodies that each are rotatable around the orthogonal direction as an axial direction, are arranged in the transport direction, and are configured to press the heating belt and the recording medium toward the support member.

### CROSS-REFERENCE TO RELATED APPLICATIONS

This application is based on and claims priority under 35 USC 119 from Japanese Patent Application No. 2016-041044 filed Mar. 3, 2016.

### BACKGROUND

The present invention relates to a fixing device and an image forming apparatus.

### SUMMARY

According to an aspect of the invention, there is provided a fixing device including a heating belt that is provided rotatably around an orthogonal direction orthogonal to a transport direction of a recording medium as an axial direction, and is configured to heat a developer on the recording medium; a support member that is provided inside the heating belt and supports the heating belt; and plural pressing rotational bodies that each are rotatable around the orthogonal direction as an axial direction, are arranged in the transport direction, and are configured to press the heating belt and the recording medium toward the support member.

### BRIEF DESCRIPTION OF THE DRAWINGS

Exemplary embodiments of the present invention will be described in detail based on the following figures, wherein:

FIG. 1 is a configuration diagram showing an image forming apparatus according to a first exemplary embodiment;

FIG. 2 is an explanatory view showing a configuration of a fixing device according to the first exemplary embodiment;

FIGS. 3A to 3C are explanatory views each showing a process of fixing a toner image at a nip part of the fixing device according to the first exemplary embodiment;

FIG. 4 is an explanatory view showing a configuration of a fixing device according to a second exemplary embodiment;

FIG. 5 is an explanatory view showing a configuration of a fixing device according to a third exemplary embodiment;

FIGS. 6A to 6C are explanatory views each showing a process of fixing a toner image at a nip part of the fixing device according to the third exemplary embodiment;

FIG. 7 is an explanatory view showing a configuration of a fixing device according to a fourth exemplary embodiment;

FIG. 8 is an explanatory view showing a configuration of a fixing device according to a first modification; and

FIG. 9 is an explanatory view showing a configuration of a fixing device according to a second modification.

### DETAILED DESCRIPTION

### First Exemplary Embodiment

Examples of a fixing device and an image forming apparatus according to a first exemplary embodiment are described.

### General Configuration

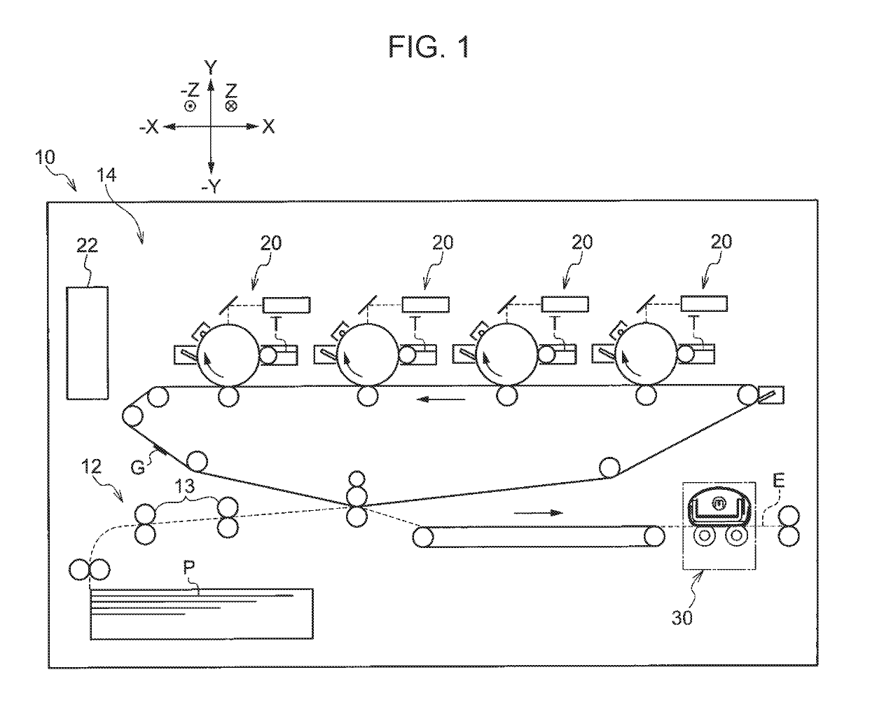

FIG. 1 shows an image forming apparatus 10 according to this exemplary embodiment. The image forming apparatus 10 includes a transport section 12 having roller pairs 13 that transport a sheet of paper P, an image forming section 14 that forms a toner image G on the sheet P transported by the transport section 12 by using a toner T, and a fixing device 30 that fixes the formed toner image G to the sheet P by heating and pressing the toner image G. The sheet P is an example of a recording medium. The toner T is an example of a developer. The toner image G is an example of a developer image. The image forming section 14 is an example of a developer image forming unit.

In the following description, it is assumed that a direction indicated by arrow Y in FIG. 1 represents an apparatus height direction, and a direction indicated by arrow X in FIG. 1 represents an apparatus width direction. Also, it is assumed that a direction (indicated by Z) orthogonal to the apparatus height direction and the apparatus width direction represents an apparatus depth direction. In front view of the image forming apparatus 10, the apparatus height direction, the apparatus width direction, and the apparatus depth direction are written as Y direction, X direction, and Z direction. Further, if one side and the other side of each of the X direction, Y direction, and Z direction are required to be distinguished from each other, in front view of the image forming apparatus 10, the upper side is written as Y side, the lower side is written as −Y side, the right side is written as X side, the left side is written as −X side, the deep side is written as Z side, and the near side is written as −Z side. A transport path E of a sheet P in the fixing device 30 extends along, for example, the X direction.

The image forming section 14 includes plural image forming units 20, and a controller 22 that controls operation of respective portions of the plural image forming units 20 and causes the image forming units 20 to form toner images G on a sheet P. Each of the image forming units 20 executes, for example, respective processes of charge with electricity, exposure to light, development, and transfer, which are included in a known electrophotographic system.

### Major Section Configuration

The fixing device 30 is described next.

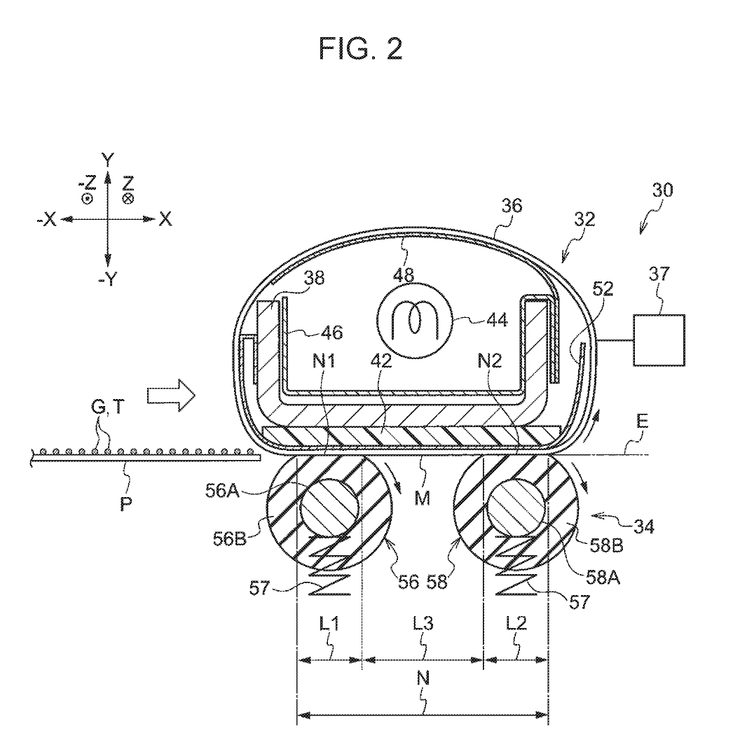

The fixing device 30 shown in FIG. 2 includes a heating unit 32 that is provided at the Y side with respect to the transport path E of the sheet P and is configured to heat the toner image G, and a pressing unit 34 that is provided at the −Y side with respect to the transport path E and is configured to press the sheet P and the toner image G toward the heating unit 32. In this exemplary embodiment, for example, the transport direction of the sheet P in the fixing device 30 is the X direction as described above, and the direction (the width direction of the sheet P) orthogonal to the X direction is the Z direction.

### Heating Unit

The heating unit 32 includes a fixing belt 36, a motor 37, a holder 38, a pad 42, a halogen lamp 44, a reflecting member 46, a heat transfer member 48, a slide sheet 52, and a temperature sensor (not shown). The fixing belt 36 is an example of a heating belt. The pad 42 is an example of a support member.

### Fixing Belt

The fixing belt 36 is an endless belt having a larger width in the Z direction than the width of the sheet P. For example, the fixing belt 36 includes a base layer and a mold release layer covering the outer peripheral surface of the base layer. The material of the base layer may be a polymer, such as polyimide, polyamide, or polyimideamide; or a metal, such as stainless steel, nickel, or copper. In this exemplary embodiment, for example, polyimide is used. The mold release layer is made of, for example, tetrafluoroethylene-perfluoalkylvinylether copolymer (PFA).

Also, the fixing belt 36 is arranged rotatably (turnably) around the Z direction as its axial direction, at the Y side with respect to the transport path E of the sheet P. To be specific, a cap having a shaft portion (not shown) is fitted to each of both end portions in the Z direction of the fixing belt 36. The shaft portion is rotatably supported by a bearing (not shown). A gear (not shown) is fitted to the shaft portion. The gear is driven by the motor 37 (described later), and hence the shaft portion and the fixing belt 36 rotate.

Further, the fixing belt 36 is sandwiched between the pad 42, and pressing rollers 56 and 58 (described later). In addition, a portion of the fixing belt 36 without the cap fitted turns to plot a movement locus close to a semicircle when viewed in the Z direction except a nip part N (described later) because of the rigidity against an external force acting toward the inside of the fixing belt 36. Also, the outer peripheral surface of the fixing belt 36 contacts the toner image G on the sheet P transported through the transport path E. Then, the fixing belt 36 is heated by the heat transfer member 48 (described later), and hence the fixing belt 36 heats the toner image G (the toner T) on the sheet P at the nip part N (described later).

The temperature of the fixing belt 36 is detected by the temperature sensor (not shown). The controller 22 (see FIG. 1) energizes the halogen lamp 44 (described later) if the temperature detected by the temperature sensor is lower than a set temperature of the fixing device 30, and stops the energization to the halogen lamp 44 if the detected temperature is higher than the set temperature. The set temperature is a temperature (a fixing temperature) at which the toner image G is able to be fixed to the sheet P.

### Motor

The motor 37 is controlled to be rotated and stopped by the controller 22 (see FIG. 1). Also, the motor 37 is connected with the fixing belt 36 through the gear and cap (not shown), and hence turns the fixing belt 36. The pressing rollers 56 and 58 (described later) are rotated by the movement of the fixing belt 36.

### Holder

The holder 38 is a long member that is made of a sheet metal and is longer than the width of the fixing belt 36 in the Z direction. The holder 38 has a U-shaped X-Y cross section. Also, the holder 38 is arranged inside the fixing belt 36 in a state open to the Y side. Both end portions in the Z direction of the holder 38 are each supported by a bracket (not shown).

### Pad

For example, the pad 42 is a resin member made of polyethylene terephthalate (PET), and being as substantially long as the width in the Z direction of the fixing belt 36. Also, the pad 42 has an X-Y cross section being a rectangular shape elongated in the X direction. Further, the pad 42 is provided inside the fixing belt 36. The pad 42 is fixed to a lower wall extending along the X direction of the holder 38 in the fixing belt 36. In addition, the slide sheet 52 (described later) contacts the surface at the −Y side of the pad 42. Both end portions in the X-direction of the pad 42 have round shapes to protrude toward the fixing belt 36. The pad 42 supports the fixing belt 36 through the slide sheet 52 when the fixing belt 36 is pressed.

### Halogen Lamp

The halogen lamp 44 is provided inside the fixing belt 36 at the Y side with respect to the reflecting member 46 (described later), in a non-contact manner with the reflecting member 46. The halogen lamp 44 has a longitudinal direction in the Z direction. A light emitting portion of the halogen lamp 44 has a length in the Z direction being substantially the same as the length in the Z direction of a sheet P with the maximum width among sheets P to be used in the image forming apparatus 10 (see FIG. 1). The halogen lamp 44 is tuned on by energization from a power supply (not shown) and radiates radiation heat (light).

### Reflecting Member

The reflecting member 46 is a member formed by bending a sheet material having a longitudinal direction in the Z direction, at plural positions, in the short-side direction, and hence is formed in a U shape. One end portion of the reflecting member 46 is fixed to the holder 38. The reflecting member 46 is arranged to cover the Y side of the holder 38, and faces the halogen lamp 44. The surface of the reflecting member 46 facing the halogen lamp 44 is a mirror. The reflecting member 46 reflects the light of the halogen lamp 44 to a side opposite to the nip part N side (to the heat transfer member 48 side).

### Heat Transfer Member

The heat transfer member 48 is a member having a larger length in the Z direction than the length in the Z direction of the fixing belt 36. The heat transfer member 48 is arranged inside the fixing belt 36 at the Y side with respect to the halogen lamp 44. Also, one end portion of the heat transfer member 48 is fixed to the holder 38 together with the reflecting member 46. A curved portion curved from the center to the other end of the heat transfer member 48 contacts the inner peripheral surface of the fixing belt 36. The heat transfer member 48 absorbs the radiation heat of the halogen lamp 44 and transfers the heat to the fixing belt 36 in the contact state with the fixing belt 36.

### Slide Sheet

The slide sheet 52 is fixed to the holder 38 to cover the surface at the −Y side of the pad 42. Also, the slide sheet 52 is sandwiched between the fixing belt 36 and the pad 42 when the fixing belt 36 is pressed by the pressing unit 34 (described later). Further, the slide sheet 52 is formed of a material so that the friction coefficient between the fixing belt 36 and the slide sheet 52 is smaller than the friction coefficient between the fixing belt 36 and the pad 42.

### Pressing Unit

The pressing unit 34 includes, for example, the pressing rollers 56 and 58 arranged in the X direction. The pressing rollers 56 and 58 each are an example of a pressing rotational body.

The pressing roller 56 is arranged at a position so as to face a portion located upstream of the center of the pad 42 in the transport direction of the sheet P, to have its axial direction in the Z direction. Also, the pressing roller 56 includes a columnar core metal 56A, and a sponge layer 56B formed on the outer peripheral surface of the core metal 56A. Both end portions in the axial direction of the core metal 56A are rotatably supported by bearings mounted on brackets (not shown).

Further, the core metal 56A is pushed by a spring 57 toward the fixing belt 36 so that the outer peripheral surface of the sponge layer 56B contacts the outer peripheral surface of the fixing belt 36 and hence forms a press region in the nip part N (described later). As described above, the pressing roller 56 is provided rotatably around the Z direction as its rotational axis, presses the fixing belt 36 toward the pad 42, and hence forms a first press region N1. The first press region N1 forms an upstream-side portion of the nip part N (an entrance-side portion of the sheet P) (described later) in the transport direction of the sheet P.

The pressing roller 58 is arranged at a position so as to face a portion located downstream of the center of the pad 42 in the transport direction of the sheet P, to have its axial direction in the Z direction. Also, the pressing roller 58 includes a columnar core metal 58A, and a sponge layer 58B formed on the outer peripheral surface of the core metal 58A. Both end portions in the axial direction of the core metal 58A are rotatably supported by bearings mounted on brackets (not shown).

Further, the core metal 58A is pushed by the spring 57 toward the fixing belt 36 so that the outer peripheral surface of the sponge layer 58B contacts the outer peripheral surface of the fixing belt 36 and hence forms a press region in the nip part N (described later). As described above, the pressing roller 58 is provided rotatably around the Z direction as its axial direction, presses the fixing belt 36 toward the pad 42, and hence forms a second press region N2. The second press region N2 forms a downstream-side portion of the nip part N (an exit-side portion of the sheet P) (described later) in the transport direction of the sheet P. The pressing rollers 56 and 58 press the fixing belt 36 and the toner image G (the toner T) on the sheet P toward the pad 42.

In this case, an area from a portion at which the fixing belt 36 and the pressing roller 56 sandwich the sheet P to a portion at which the fixing belt 36 and the pressing roller 58 sandwich the sheet P is called nip part N. That is, the pressing rollers 56 and 58 form the nip part N at which the pressing rollers 56 and 58 sandwich the sheet P with the fixing belt 36. In this exemplary embodiment, for example, the nip part N is formed linearly along the X direction when viewed in the Z direction.

Also, in this exemplary embodiment, for example, the outer diameter of the core metal 56A is substantially equivalent to the outer diameter of the core metal 58A, and the outer diameter of the sponge layer 56B is substantially equivalent to the outer diameter of the sponge layer 58B. A width L1 in the X direction of the first press region N1 is substantially equivalent to a width L2 in the X direction of the second press region N2. It is assumed that a region between the first press region N1 and the second press region N2 in the nip part N is called intermediate region M. For example, a width L3 in the X direction of the intermediate region M is larger than the width L1 and the width L2. The total width in the X direction of the nip part N is L1+L2+L3.

The intermediate region M is a region where the fixing belt 36 is supported by the pad 42 from the inner side (the Y side) and the sheet P is not supported from the −Y side. That is, in the intermediate region M, the sheet P has a tension in the X direction by the pressures in the first press region N1 and the second press region N2; however, a pressing force does not act on the sheet P. In this case, regarding a force per unit area acting on the sheet P in the nip part N, it is assumed that PS1 is a pressing force in the first press region N1, PS2 is a pressing force in the second press region N2, and PS3 (=0) is a pressing force in the intermediate region M. In this exemplary embodiment, for example, a relationship of PS1=PS2>PS3 is established.

### Operation

Operation according to the first exemplary embodiment is described next.

In the image forming apparatus 10 shown in FIG. 1, rising operation of the fixing device 30 is started in synchronization with formation of a toner image G on a sheet P by the image forming section 14. To be specific, in the fixing device 30 shown in FIG. 2, the halogen lamp 44 is turned on, the motor 37 starts turning the fixing belt 36, and the pressing rollers 56 and 58 start being rotated. At this time, in a portion at a side opposite to the nip part N side, the heat transfer member 48 heated by the halogen lamp 44 contacts the inner peripheral surface of the fixing belt 36, hence the fixing belt 36 is heated, and the temperature of the fixing belt 36 becomes the fixing temperature. At the nip part N, the toner image G on the transported sheet P is heated, pressed, and fixed to the sheet P.

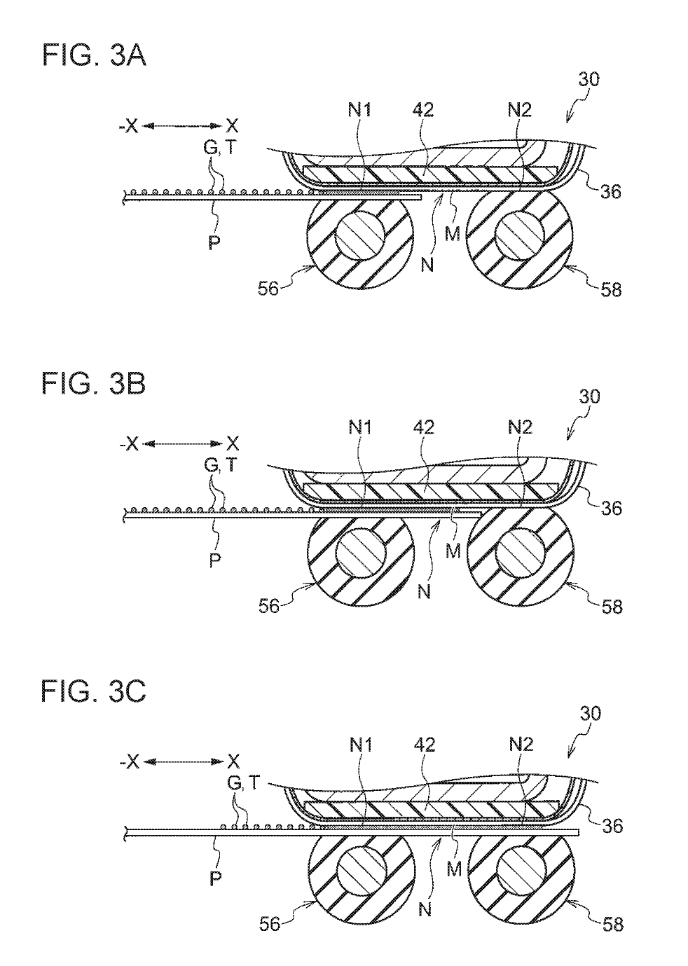

To be specific, as shown in FIG. 3A, the toner image G on the sheet P entering the nip part N is heated and molten by the fixing belt 36, and starts being pressed with a pressing force by the pressing roller 56 in the first press region N1.

Then, as shown in FIG. 3B, the toner image G on the sheet P passing through the first press region N1 and entering the intermediate region M is continuously heated by the fixing belt 36, and the melting progresses.

Then, as shown in FIG. 3C, the toner image G on the sheet P entering the second press region N2 from the intermediate region M is heated and molten by the fixing belt 36, and pressed with a pressing force by the pressing roller 58 in the second press region N2. In this way, the toner image G on the sheet P is fixed to the sheet P by heating in the three steps and pressing in the two steps.

In the fixing device 30 shown in FIG. 2, since the first press region N1 and the second press region N2 are formed, a large nip width is ensured as compared with a case where the nip part N is formed by a single pressing member. Further, since the pressing forces act on the sheet P in the first press region N1 and the second press region N2, the sheet P has a tension in the transport direction in the intermediate region M, and the toner image G on the sheet P is heated. That is, the nip part N includes not only the first press region N1 and the second press region N2, but also the intermediate region M. Thus, a further large nip width is ensured.

Also, in the fixing device 30, the nip part N is formed by using the plural pressing rollers 56 and 58. The outer diameters of the pressing rollers 56 and 58 may be decreased as compared with a configuration in which the nip part N is formed by using a single belt. Accordingly, the contact area between the fixing belt 36 and the pressing member at the nip part N is decreased, and variation in the pressing force in the Z direction at the nip part N is restricted. Hence, meandering of the fixing belt 36 in the Z direction is restricted. In particular, in the fixing device 30, the pressing rollers 56 and 58 forming the pressing unit 34 rotate. Hence, as compared with a configuration including a non-rotational pressing member, turning of the fixing belt 36 is stabilized, and meandering in the Z direction of the fixing belt 36 is restricted.

Further, in the fixing device 30, pressing on the fixing belt 36 is provided in the first press region N1 and the second press region N2 in the nip part N; however, pressing on the fixing belt 36 is almost not provided in the intermediate region M. Hence, variation in the pressing force in the Z direction at the nip part N is restricted and meandering in the Z direction of the fixing belt 36 is restricted as compared with a configuration in which pressing is provided with the entire nip part N.

In addition, in the fixing device 30, by using the pressing rollers 56 and 58, the diameters of the pressing rollers 56 and 58 are decreased, that is, the space required for arranging the pressing unit 34 is decreased as compared with a case where the same nip width is provided by using a single pressing roller. Accordingly, the fixing device 30 may be decreased in size.

Also, in the fixing device 30, the intermediate region M is formed and the width L3 of the intermediate region M is larger than the width L1 of the first press region N1 and the width L2 of the second press region N2. Accordingly, the region where the sheet P is pressed is decreased and hence the sheet P is almost not wrinkled as compared with a configuration in which pressing is provided with the entire nip part N.

In the image forming apparatus 10 (see FIG. 1), since meandering in the Z direction of the fixing belt 36 is restricted in the fixing device 30, when the toner image G is fixed to the sheet P, misregistration of the toner image G on the sheet P is restricted. Accordingly, as compared with a configuration without the fixing device 30, image defect (for example, misregistration of an image) in the image forming apparatus 10 is restricted.

### Second Exemplary Embodiment

Examples of a fixing device and an image forming apparatus according to a second exemplary embodiment are described. The same reference signs as those of the first exemplary embodiment are applied to the basically same members and portions as those of the first exemplary embodiment, and redundant description is omitted.

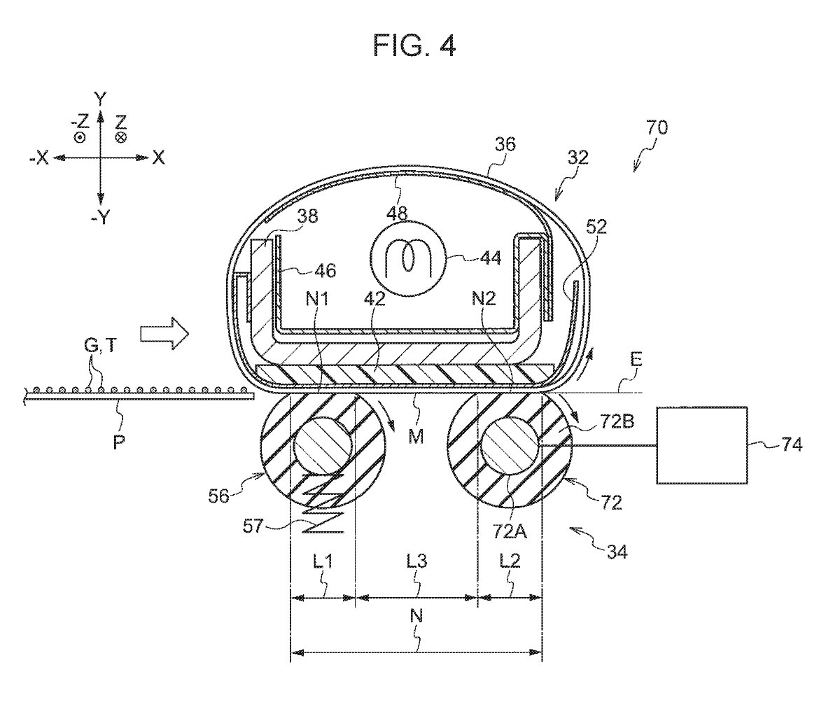

FIG. 4 illustrates a fixing device 70 according to the second exemplary embodiment. The fixing device 70 differs from the fixing device 30 (see FIG. 2) according to the first exemplary embodiment in that the fixing device 70 includes a driving roller 72 and a motor 74 instead of the pressing roller 58 (see FIG. 2). The driving roller 72 is an example of a pressing rotational body. The motor 74 is an example of a driving unit. Also, the motor 37 (see FIG. 2) is removed from the fixing belt 36, and the fixing belt 36 is rotated by the rotation of the driving roller 72.

The driving roller 72 is arranged at a position so as to face a portion located downstream of the center of the pad 42 in the transport direction of the sheet P (the X direction), to have its axial direction in the Z direction. That is, the driving roller 72 is arranged at the most downstream side in the transport direction. Also, the driving roller 72 includes a columnar core metal 72A, and a rubber layer 72B formed on the outer peripheral surface of the core metal 72A. Both end portions in the axial direction of the core metal 72A are rotatably supported by bearings mounted on brackets (not shown).

The arrangement of the core metal 72A with respect to the pad 42 and the fixing belt 36 is previously set so that the outer peripheral surface of the rubber layer 72B contacts the outer peripheral surface of the fixing belt 36 and the second press region N2 is formed in the nip part N. That is, the driving roller 72 is not pressed by a spring; however, the driving roller 72 presses the fixing belt 36 and the sheet P (including the toner image G).

The motor 74 is controlled to be rotated and stopped by the controller 22 (see FIG. 1). Also, the motor 74 is connected with one end portion in the Z direction of the core metal 72A through a gear (not shown) and hence rotates the driving roller 72 around the axis.

### Operation

Operation according to the second exemplary embodiment is described next.

In the fixing device 70 shown in FIG. 4, when the motor 74 is driven and the driving roller 72 is rotated, the fixing belt 36 is turned. Then, since the fixing belt 36 is turned, the pressing roller 56 is rotated. In this case, the sheet P entering the second press region N2 from the intermediate region M is pressed in the second press region N2 and is transported with a tension toward the downstream side in the X direction by the rotation of the driving roller 72. Accordingly, as compared with a configuration in which all pressing rollers are rotated, the sheet P enters the second press region N2 with ease, and transport performance of the sheet P is increased.

In the image forming apparatus 10 (see FIG. 1) including the fixing device 70, since meandering in the Z direction of the fixing belt 36 is restricted in the fixing device 70, when the toner image G is fixed to the sheet P, misregistration of the toner image G on the sheet P is restricted. Accordingly, as compared with a configuration without the fixing device 70, image defect (for example, misregistration of an image) in the image forming apparatus 10 is restricted.

### Third Exemplary Embodiment

Examples of a fixing device and an image forming apparatus according to a third exemplary embodiment are described. The same reference signs as those of the first and second exemplary embodiments are applied to the basically same members and portions as those of the first and second exemplary embodiments, and redundant description is omitted.

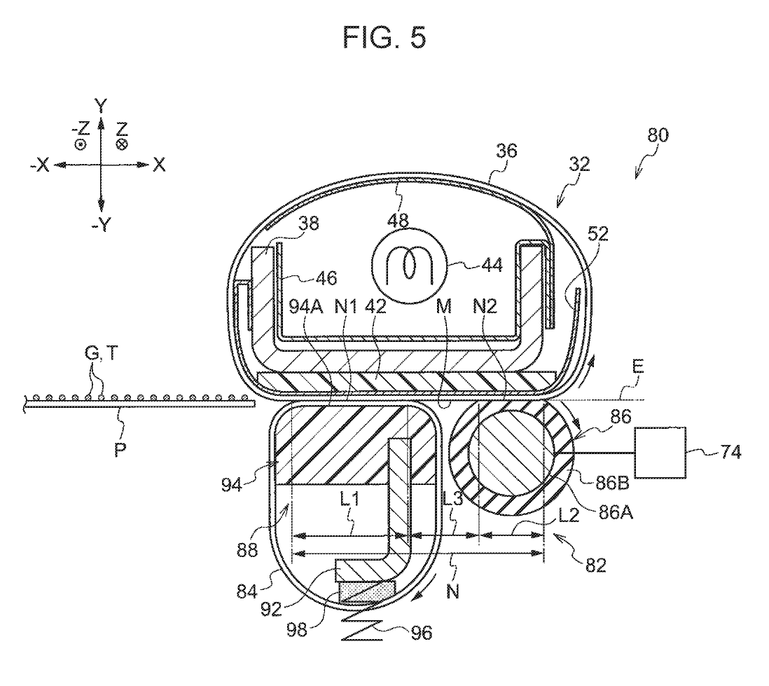

FIG. 5 illustrates a fixing device 80 according to the third exemplary embodiment. The fixing device 80 includes the heating unit 32 and a pressing unit 82. Also, the motor 37 (see FIG. 2) is removed from the fixing belt 36, and the fixing belt 36 is rotated by the rotation of a driving roller 86 (described later).

The pressing unit 82 includes, for example, a pressing belt 84 and the driving roller 86 arranged in the X direction, the motor 74, and a pushing portion 88 that is provided inside the pressing belt 84 and pushes the pressing belt 84 and the fixing belt 36 toward the pad 42. The pressing belt 84 and the driving roller 86 each are an example of a pressing rotational body. The pushing portion 88 is an example of a pushing part.

### Driving Roller

The driving roller 86 is arranged at a position so as to face a portion located downstream of the center of the pad 42 in the X direction being the transport direction of the sheet P, to have its axial direction in the Z direction. Also, the driving roller 86 includes a columnar core metal 86A, and a rubber layer 86B formed on the outer peripheral surface of the core metal 86A. Both end portions in the axial direction of the core metal 86A are rotatably supported by bearings mounted on brackets (not shown).

The arrangement of the core metal 86A with respect to the pad 42 and the fixing belt 36 is previously set so that the outer peripheral surface of the rubber layer 86B contacts the outer peripheral surface of the fixing belt 36 and the second press region N2 is formed in the nip part N. That is, the core metal 86A is not pressed by a pressing part such as a spring; however, the core metal 86A presses the fixing belt 36 and the sheet P (including the toner image G). The material of the rubber layer 86B (for example, silicon rubber) is determined so that the pressing force in the second press region N2 is larger than the pressing force in the first press region N1. The motor 74 is connected with one end portion in the Z direction of the core metal 86A through a gear (not shown) and hence rotates the driving roller 86 around the axis.

### Pressing Belt

The pressing belt 84 is an endless belt having a larger width in the Z direction than the width of the sheet P. For example, the pressing belt 84 includes a base layer and a mold release layer covering the outer peripheral surface of the base layer. The material of the base layer may be a polymer, such as polyimide, polyamide, or polyimideamide; or a metal, such as stainless steel, nickel, or copper. In this exemplary embodiment, for example, polyimide is used. The mold release layer is made of, for example, tetrafluoroethylene-perfluoalkylvinylether copolymer (PFA).

Also, the pressing belt 84 is provided rotatably (turnably) around the Z direction as its axial direction, at a position so as to face a portion located upstream of the center of the pad 42 in the X direction. To be specific, the pressing belt 84 is sandwiched between the fixing belt 36 and a pressing pad 94 (described later). The pressing belt 84 is rotated by the rotation of the fixing belt 36 rotated by the rotation of the driving roller 86.

Further, the pressing belt 84 forms the first press region N1 at which the pressing belt 84 sandwiches the sheet P with the fixing belt 36. The first press region N1 forms the upstream-side portion of the nip part N (the entrance-side portion of the sheet P) in the transport direction of the sheet P. The outer peripheral surface of the pressing belt 84 contacts a surface of the sheet P at a side opposite to the toner image G on the sheet P transported through the transport path E. The pressing belt 84 is pushed by the pushing portion 88 (described later), and hence presses the toner image G on the sheet P.

### Pushing Portion

The pushing portion 88 includes, for example, a holder 92, the pressing pad 94, and a spring 96.

The holder 92 is a member formed by bending a sheet metal having a longitudinal direction in the Z direction, in the short-side direction. The holder 92 is formed in an inverted L shape when viewed in the Z direction. Also, the holder 92 is arranged inside the pressing belt 84 so as not to contact the pressing belt 84. Both end portions in the Z direction of the holder 92 are supported by brackets (not shown). A felt member 98 is mounted on the holder 92. The felt member 98 contains oil and contacts the inner peripheral surface of the pressing belt 84.

The pressing pad 94 is fixed to a Y-side end portion of the holder 92, and is arranged inside the pressing belt 84 at the Y side (the nip part N side). Also, the pressing pad 94 is made of resin and formed in a rectangular parallelepiped shape having a longitudinal direction in the Z direction. The pressing pad 94 has an upper surface 94A along an X-Z plane. The width in the X direction of the upper surface 94A is substantially equivalent to a width L1 in the X direction of the first press region N1. Further, a portion of the pressing pad 94, the portion which is an end portion at the pressing belt 84 side and both end portions in the X direction, has a round shape. A portion of the pressing belt 84 is wound around the portion of the pressing pad 94.

The spring 96 is sandwiched between a bracket (not shown) provided in the fixing device 80 and the holder 92 and is compressed in the Y direction. Hence, the spring 96 pushes the holder 92 toward the Y side (the nip part N side). In this exemplary embodiment, a phenomenon that the spring 96 pushes the holder 92 and the pressing belt 84 is called pushing, and a phenomenon that the pressing belt 84 pushed by the spring 96 presses the fixing belt 36 is called pressing. These phenomena are distinguished from each other. In this case, the widths in the X direction of the first press region N1, the second press region N2, and the intermediate region M according to the third exemplary embodiment have a relationship of L1>L3>L2.

### Operation

Operation according to the third exemplary embodiment is described next.

In the fixing device 80 shown in FIG. 5, when the motor 74 is driven and the driving roller 86 is rotated, the fixing belt 36 is turned. Then, since the fixing belt 36 is turned, the pressing belt 84 is rotated.

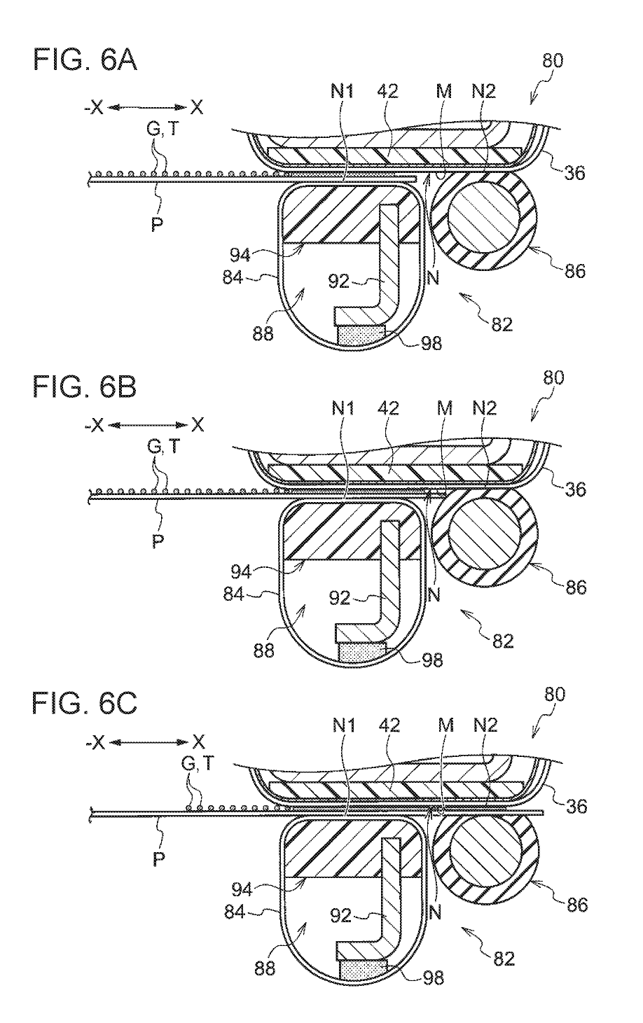

As shown in FIG. 6A, the toner image G on the sheet P entering the nip part N is heated and molten by the fixing belt 36, and starts being pressed with a pressing force by the pushing portion 88 and the pressing belt 84 in the first press region N1.

Then, as shown in FIG. 6B, the toner image G on the sheet P passing through the first press region N1 and entering the intermediate region M is continuously heated by the fixing belt 36, and melting progresses.

Then, as shown in FIG. 6C, the toner image G on the sheet P entering the second press region N2 from the intermediate region M is heated and molten by the fixing belt 36, and pressed with a pressing force by the driving roller 86 in the second press region N2. In this way, the toner image G on the sheet P is fixed to the sheet P by heating in the three steps and pressing in the two steps.

In this case, in the fixing device 80, the sheet P entering the second press region N2 from the intermediate region M is pressed in the second press region N2 and is transported with a tension toward the downstream side in the X direction by the rotation of the driving roller 86. Accordingly, as compared with a configuration in which all pressing rollers at the pressing unit 82 side are rotated, the sheet P enters the second press region N2 with ease, and transport performance of the sheet P is increased.

Further, in the fixing device 80 shown in FIG. 5, the pressing rotational body that forms the first press region N1 is the pressing belt 84. Accordingly, as compared with the configuration of the pressing roller in which the pressing rotational body includes the core metal and the elastic layer, the thermal capacity of the pressing rotational body is decreased, and the rising time from the operation start time point of the fixing device 80 is decreased.

Also, in the fixing device 80, since the pressing pad 94 is formed in the rectangular parallelepiped shape, as compared with the configuration using the pressing roller, the first press region N1 may be close to the second press region N2 and the width in the X direction of the intermediate region M may be decreased. Also, as compared with the configuration using the pressing roller, the width L1 in the X direction of the first press region N1 may be increased, and the width L2 in the X direction of the second press region N2 may be decreased. Accordingly, the rubber layer 86B of the driving roller 86 may be thinned, and the outer diameter of the driving roller 86 may be decreased.

In the image forming apparatus 10 (see FIG. 1) including the fixing device 80, since meandering in the Z direction of the fixing belt 36 is restricted in the fixing device 80, when the toner image G is fixed to the sheet P, misregistration of the toner image G on the sheet P is restricted. Accordingly, as compared with a configuration without the fixing device 80, image defect (for example, misregistration of an image) in the image forming apparatus 10 is restricted.

### Fourth Exemplary Embodiment

Examples of a fixing device and an image forming apparatus according to a fourth exemplary embodiment are described. The same reference signs as those of the first to third exemplary embodiments are applied to the basically same members and portions as those of the first to third exemplary embodiments, and redundant description is omitted.

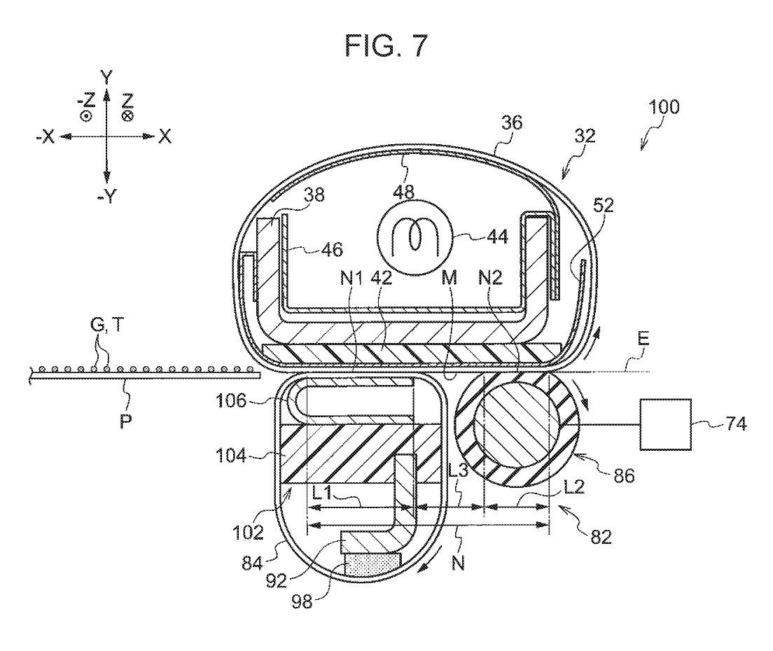

FIG. 7 illustrates a fixing device 100 according to the fourth exemplary embodiment. The fixing device 100 differs from the fixing device 80 (see FIG. 5) according to the third exemplary embodiment in that the fixing device 100 is provided with a pushing portion 102 instead of the pushing portion 88 (see FIG. 5). The pushing portion 102 is an example of a pushing part.

The pushing portion 102 is arranged inside the pressing belt 84. For example, the pushing portion 102 includes the holder 92, a mount plate 104, and a leaf spring 106. The leaf spring 106 is an example of an elastic body.

The mount plate 104 is fixed to an end portion at the Y side of the holder 92, and arranged inside the pressing belt 84 substantially at the center in the Y direction. Also, the mount plate 104 is made of resin and formed in a rectangular parallelepiped shape to have a longitudinal direction in the Z direction. Further, the mount plate 104 has both ends in the X direction being side surfaces along a Y-Z plane. The side surfaces contact the inner peripheral surface of the pressing belt 84.

The leaf spring 106 is formed in a U shape when viewed in the Z direction by bending a plate member having a longitudinal direction in the Z direction, in the short-side direction. Also, the leaf spring 106 is arranged so that the X side thereof is open. The leaf spring 106 is fixed to a surface at the Y side of the mount plate 104 by using a screw (not shown), and hence is arranged inside the pressing belt 84. Further, a portion at the Y side of the leaf spring 106 contacts the inner peripheral surface of the pressing belt 84 in a manner compressed in the Y direction. That is, the leaf spring 106 is configured to cause an elastic force to act on the pressing belt 84. Hence, the leaf spring 106 pushes the pressing belt 84 toward the fixing belt 36. Thus, the leaf spring 106 forms the first press region N1.

### Operation

Operation according to the fourth exemplary embodiment is described next.

In the fixing device 100 shown in FIG. 7, when the motor 74 is driven and the driving roller 72 is rotated, the fixing belt 36 is turned. Then, since the fixing belt 36 is turned, the pressing belt 84 is rotated. In this case, the sheet P entering the second press region N2 from the intermediate region M is pressed in the second press region N2 and is transported with a tension toward the downstream side in the X direction by the rotation of the driving roller 72. Accordingly, as compared with a configuration in which all pressing rollers at the pressing unit 82 side are rotated, the sheet P enters the second press region N2 with ease, and transport performance of the sheet P is increased.

Also, in the fixing device 100, the single leaf spring 106 is arranged inside the pressing belt 84 and is configured to cause an elastic force to act on the pressing belt 84. That is, the elastic force of the leaf spring 106 directly acts on the first press region N1. Accordingly, since the shape of the mount plate 104 does not relate to the pressing state, as compared with a configuration in which the mount plate 104 is pushed by an elastic body provided outside the pressing belt 84 and hence the pressing belt 84 is pushed, variation in the pressing force in the Z direction in the first press region N1 of the nip part N is restricted.

In the image forming apparatus 10 (see FIG. 1) including the fixing device 100, since meandering in the Z direction of the fixing belt 36 is restricted in the fixing device 100, when the toner image G is fixed to the sheet P, misregistration of the toner image G on the sheet P is restricted. Accordingly, as compared with a configuration without the fixing device 100, image defect (for example, misregistration of an image) in the image forming apparatus 10 is restricted.

The present invention is not limited to the above-described exemplary embodiments.

### First Modification

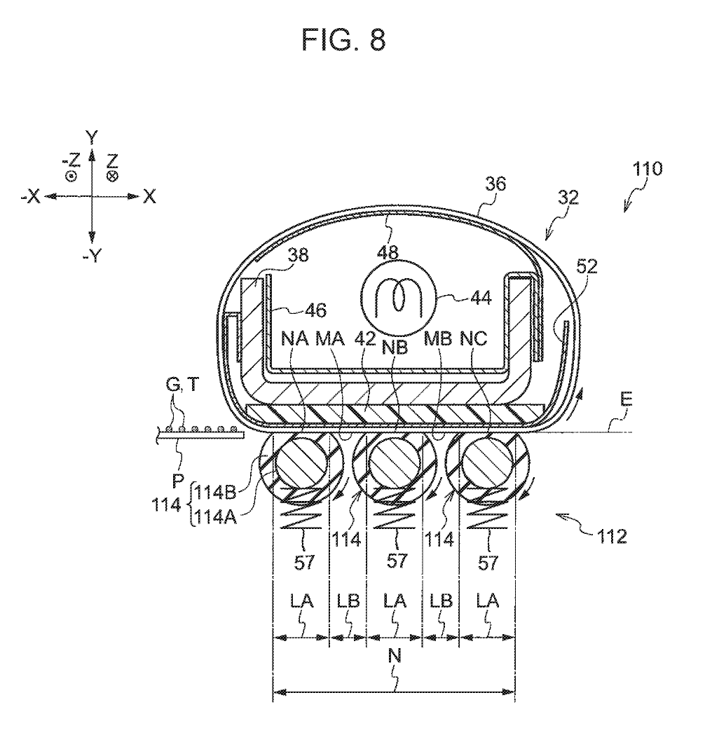

FIG. 8 illustrates a fixing device 110 as a modification (a first modification) of the fixing device 30 (see FIG. 2) according to the first exemplary embodiment. The fixing device 110 includes the heating unit 32 and a pressing unit 112.

The pressing unit 112 includes, for example, three pressing rollers 114 arranged in the X direction. The three pressing rollers 114 each are an example of a pressing rotational body.

The three pressing rollers 114 are arranged at an upstream side, the center, and a downstream side of the nip part N in the transport direction of the sheet P, to have its axial direction in the Z direction. Also, the three pressing rollers 114 each include a columnar core metal 114A, and a sponge layer 114B formed on the outer peripheral surface of the core metal 114A. Both end portions in the axial direction of each core metal 114A are rotatably supported by bearings mounted on brackets (not shown).

Further, the three core metals 114A are each pressed by the spring 57 toward the fixing belt 36 so that the outer peripheral surface of the sponge layer 114B contacts the outer peripheral surface of the fixing belt 36 and hence forms a press region in the nip part N. As described above, the pressing roller 56 is provided rotatably around the Z direction as its axial direction, presses the fixing belt 36 toward the pad 42, and hence forms a first press region NA, a second press region NB, and a third press region NC.

An intermediate region MA where the sheet P is not pressed is formed between the first press region NA and the second press region NB in the nip part N. Also, an intermediate region MB where the sheet P is not pressed is formed between the second press region NB and the third press region NC in the nip part N. The widths in the X direction of the first press region NA, the second press region NB, and the third press region NC each are LA. Also, the widths in the X direction of the intermediate region MA and the intermediate region MB each are LB (<LA). In this case, in the fixing device 110, the three pressing rollers 114 rotate. Hence, as compared with a configuration including a non-rotational pressing member, movement of the fixing belt 36 is stabilized. As described above, in the fixing device 110, since the movement of the fixing belt 36 is stabilized, meandering in the Z direction of the fixing belt 36 is restricted, and the transport performance of the sheet P is increased.

### Second Modification

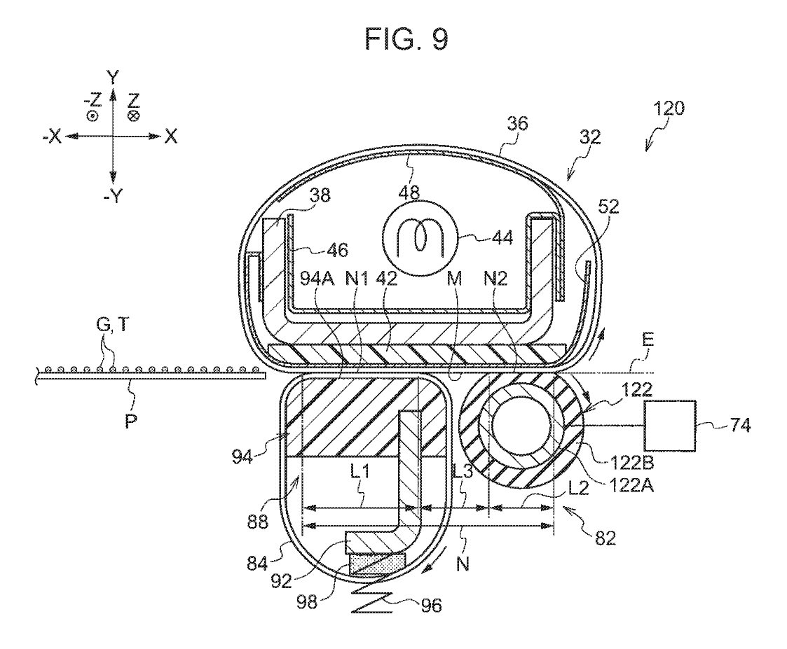

FIG. 9 illustrates a fixing device 120 as a modification (a second modification) of the fixing device 80 (see FIG. 5) according to the third exemplary embodiment.

The fixing device 120 is provided with a driving roller 122 as an example of a pressing rotational body instead of the driving roller 86 of the fixing device 80 (see FIG. 5). The other configuration except the driving roller 122 is similar to the configuration of the fixing device 80.

The driving roller 122 is provided at a position so as to face a portion located downstream of the center of the pad 42 in the X direction being the transport direction of the sheet P, to have its axial direction in the Z direction. Also, the driving roller 122 includes a cylindrical core metal 122A being an example of a shaft portion, and a rubber layer 122B formed on the outer peripheral surface of the core metal 122A. Both end portions in the axial direction of the core metal 122A are rotatably supported by bearings mounted on brackets (not shown). In this way, the driving roller 122 is a roller in which the rotating core metal 122A is hollow when viewed in the Z direction. The rubber layer 122B has a configuration similar to that of the above-described rubber layer 86B (see FIG. 5).

The arrangement of the core metal 122A with respect to the pad 42 and the fixing belt 36 is previously set so that the outer peripheral surface of the rubber layer 122B contacts the outer peripheral surface of the fixing belt 36 and the second press region N2 is formed in the nip part N. That is, the core metal 122A is not pressed by a pressing part such as a spring; however, the core metal 122A presses the fixing belt 36 and the sheet P (including the toner image G). The material of the rubber layer 122B (for example, silicon rubber) is determined so that the pressing force in the second press region N2 is larger than the pressing force in the first press region N1. The motor 74 is connected with one end portion in the Z direction of the core metal 122A through a gear (not shown) and hence rotates the driving roller 122 around the axis.

In the fixing device 120, the driving roller 122 and the pressing belt 84 rotate. Hence, as compared with a configuration including a non-rotational pressing member, movement of the fixing belt 36 is stabilized. As described above, in the fixing device 120, since the movement of the fixing belt 36 is stabilized, meandering in the Z direction of the fixing belt 36 is restricted, and the transport performance of the sheet P is increased.

Further, in the fixing device 120, the core metal 122A of the driving roller 122 is hollow. Hence, in the fixing device 120, the thermal capacity of the driving roller 122 is decreased as compared with a configuration in which the core metal 122A is a solid roller. The heat of the fixing belt 36 is prevented from being removed by the pressing roller.

### Other Modifications

The number of pressing rollers each serving as an example of a pressing rotational body is not limited to two or three, and may be four or more. Also, the pressing roller and the driving roller being examples of pressing rotational bodies do not have to have a single hollow shaft portion, and may have plural (including all) hollow shaft portions. Pressing forces acting on plural press regions may not be the same pressing force. The pressing force in the press region at the downstream side in the transport direction of the sheet P may be larger than the pressing force in the press region at the upstream side. Alternatively, the pressing force in the press region at the upstream side in the transport direction of the sheet P may be larger than the pressing force in the press region at the downstream side. For another example of a pressing rotational body, caps may be fitted to both end portions in the Z direction of the pressing belt and may be rotated.

The pressing part of the pressing roller is not limited to the configuration that is configured to cause the elastic force of the spring to act on the core metal. Plural bearings that support plural core metals may be supported by a single bracket, and an elastic force by a spring may be caused to act on this bracket.

In the fixing device 100, rubber may be provided instead of the leaf spring 106, and may press the pressing belt 84.

Oil or grease may be applied to the inner peripheral surface of the fixing belt 36.

In the fixing devices 30, 70, 80, 100, 110, and 120, a heating part of the fixing belt 36 is not limited to the halogen lamp 44 or the heat transfer member 48. For example, a method of bringing a planar heat generating element into contact with the inner peripheral surface of the fixing belt 36 and heating the fixing belt 36, or a method of electromagnetic induction heating of providing a heat generating layer made of metal on the fixing belt 36, causing a magnetic field to act on the heat generating layer, and generating heat may be used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a heating belt that is provided rotatably around an orthogonal direction orthogonal to a transport direction of a recording medium as an axial direction, and is configured to heat a developer on the recording medium;
a support member that is provided inside the heating belt and supports the heating belt; and
a plurality of pressing rotational bodies that each are rotatable around the orthogonal direction as an axial direction, are arranged in the transport direction, and are configured to press the heating belt and the recording medium toward the support member.

2. The fixing device according to claim 1, wherein the pressing rotational body arranged at a most downstream side in the transport direction among the plurality of pressing rotational bodies is a driving roller that is rotated by a driving unit.

3. The fixing device according to claim 1, wherein at least one of the plurality of pressing rotational bodies is a roller having a hollow shaft portion.

4. The fixing device according to claim 1, wherein the pressing rotational body provided at an upstream side in the transport direction among the plurality of pressing rotational bodies is a pressing belt.

5. The fixing device according to claim 4, further comprising an elastic body that is provided inside the pressing belt and is configured to cause an elastic force to act on the pressing belt.

6. An image forming apparatus comprising:
a developer image forming unit that forms a developer image on a recording medium; and
the fixing device according to claim 1 that fixes the developer image on the recording medium formed by the developer image forming unit, to the recording medium.
